(19) United States
(12) Patent Application Publication
(10) Pub. No.: US 2022/0282538 A1
(43) Pub. Date: Sep. 8, 2022

(54) Adjustable Door Hinge System

(71) Applicant: Whirlpool Corporation, Benton Harbor, MI (US)

(72) Inventor: Christopher A. JONES, St. Joseph, MI (US)

(21) Appl. No.: 17/194,275

(22) Filed: Mar. 7, 2021

(51) Int. Cl. E05D 7/04; E05D 3/02

(52) U.S. Cl. CPC E05D 7/04; E05D 3/02; E05Y 2900/312; E05Y 2900/30; E05Y 2900/31; E05Y 2600/312; E05Y 2600/12

(57) ABSTRACT

A hinge assembly for a door of a household appliance has a first hinge and a second hinge. The first hinge includes a base portion and a door receiving portion. The base portion includes at least one elongated slot to receive a fastener. The elongated slot enables positioning of the door receiving portion. The second hinge includes a mounting block and a door plate. The door plate has a door receiving portion that has at least one elongated slot to enable positioning of the door receiving portion. The door plate is secured via at least one fastener to the mounting block. The mounting block is movable in a direction substantially perpendicular to the door plate for positioning the door.

### FIELD

The present disclosure relates to household appliances such as washers, dryers, refrigerators or the like and, more particularly, to an adjustable door hinge system.

### BACKGROUND

When securing an appliance door to the housing unit, door alignment with the housing unit for panel gap adjustment and fit and finish poses a consistent problem. This is due to component and assembly variation. Accordingly, when a door is applied to the housing unit, there is the possibility that gap or misalignment may occur during the assembly process. Thus, it is desirable to adjust the door to eliminate the gap and provide an aesthetic fit/finish. It would be desirable to be able to adjust the door during the assembly process to compensate for gaps as well as provide an aesthetic appearance.

The present disclosure provides the art with an adjustable hinge assembly that enables the door, during assembly, to be adjusted onto the housing unit. The door is able to move in two degrees of freedom of direction path. Thus, the door may move fore and aft as well as side to side to compensate for gaps as well as fit/finish alignment to provide an aesthetic appearance of the appliance.

### SUMMARY

According to a first aspect of the present disclosure, a hinge assembly for a door for a household appliance comprises a first hinge and a second hinge. The first hinge includes a base portion and a door receiving portion. The base portion includes at least one elongated slot to receive a fastener. The elongated slot enables positioning of the door receiving portion. The second hinge includes a mounting block and a door plate. The door plate, with a door receiving portion, includes at least one elongated slot to enable positioning of the door receiving portion. The door plate is secured via at least one fastener to the mounting block. The mounting block is movable in a direction substantially perpendicular to the door plate to position the door. The first hinge is positioned with respect to the second hinge so that the elongated slots are positioned with respect to one another to enable a first and second, fore and aft, adjustment direction of the door. The mounting block enables movement in a direction substantially transverse to the first and second movement directions. The transverse movement enables side to side adjustment of the door. The door receiving portions include a bearing to receive a door shaft. The door plate includes a channel running parallel with the at least one slot. The mounting block includes a tongue engaging the channel to enable movement of the door plate with respect to the mounting block.

According to a second embodiment, a household appliance device, such as washer, dryer or refrigerator comprises a frame, panels secured to the frame defining a housing unit and a treatment device is inside the housing unit. The housing unit includes an opening to receive a door and a hinge system is secured with the frame. The frame includes a channel to receive the mounting block. The channel is sized to enable movement of the mounting block in and along the channel. A hinge assembly for a door for a household appliance comprises a first hinge and a second hinge. The first hinge includes a base portion and a door receiving portion. The base portion includes at least elongated slot to receive a fastener. The elongated slot enables positioning of the door receiving portion. The second hinge includes a mounting block and a door plate. The door plate, with a door receiving portion, includes at least one elongated slot to enable positioning of the door receiving portion. The door plate is secured via at least one fastener to the mounting block. The mounting block is movable in a direction substantially perpendicular to the door plate to position the door. The first hinge is positioned with respect to the second hinge so that the elongated slots are positioned with respect to one another to enable a first and second, fore and aft, adjustment direction of the door. The mounting block enables movement in a direction substantially transverse to the first and second movement directions. The transverse movement enables side to side adjustment of the door. The door receiving portions include a bearing to receive a door shaft. The door plate includes a channel running parallel with the at least one slot. The mounting block includes a tongue engaging the channel to enable movement of the door plate with respect to the mounting block.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a household appliance with the door opened.

FIG. 2 is an exploded view of FIG. 1.

FIG. 3 is an exploded view of the upper hinge.

FIG. 4 is an exploded view of the lower hinge.

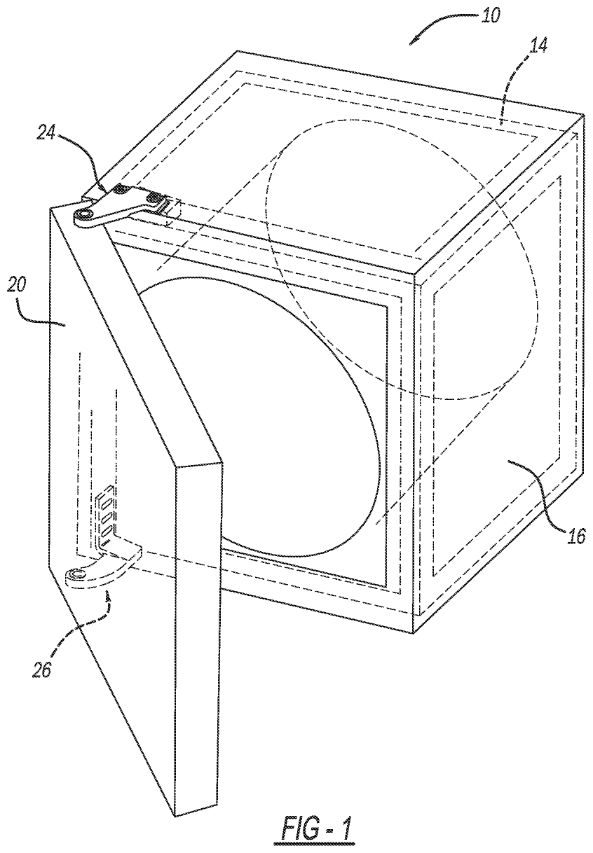

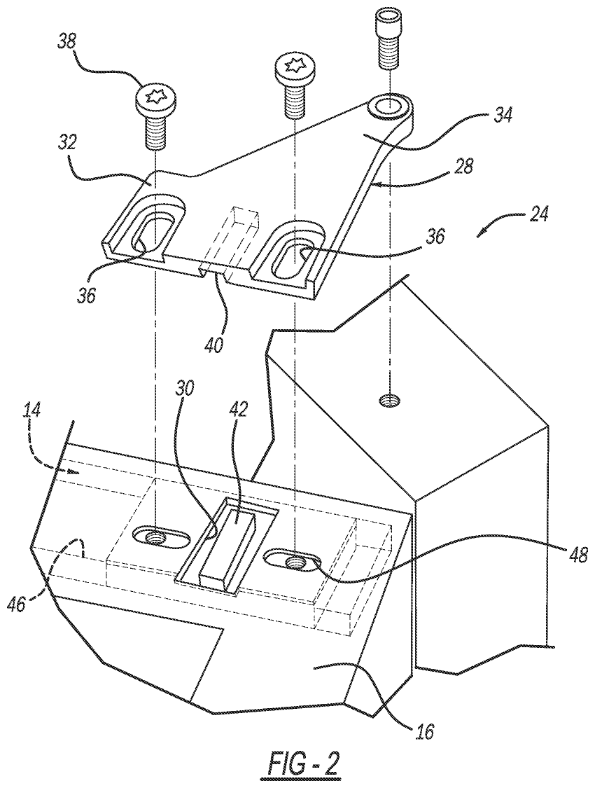

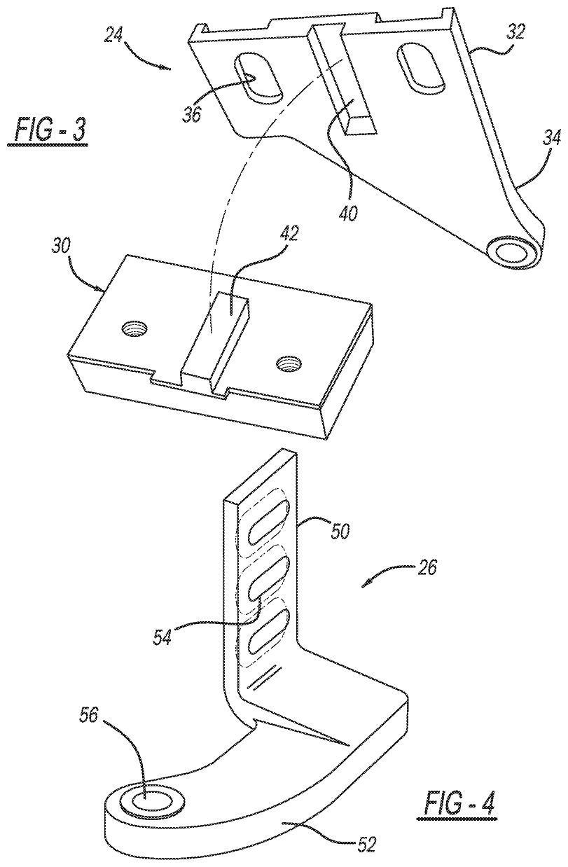

### DETAILED DESCRIPTION

Example embodiments will now be described more fully with reference to the accompanying drawings.

Turning to the figures, a household appliance, such as a washer, dryer or refrigerator is illustrated and designated with the reference numeral 10. The appliance includes a housing unit 12 that includes a frame 14 that supports the panels 16 forming the housing unit 12. The housing unit includes an opening 18 enabling access into the appliance that includes conventional operating equipment.

The door 20 is secured with the housing unit 12 via a hinge assembly 22. The hinge assembly 22 includes an upper hinge 24 and a lower hinge 26. The upper and lower hinges 24, 26 receive the door 20 to position the door 20 with respect to the housing unit 12.

The upper hinge 24 includes a door plate 28 and a mounting block 30. The door plate 28 has an overall triangular shape with a mounting portion 32 and a door receiving portion 34. The mounting portion 32 includes at least one, two shown in the embodiment, elongated slots 36. The slots 36 enable fasteners 38 to pass through the door plate 28 and secure with the mounting block 30. The mounting portion 32 includes a channel 40 that receives a tongue 42 on the mounting block 30. The channel 40 and tongue 42 act as keyed members to enable the door plate 28 to move or slide with respect to the mounting block 30. Additionally, the tongue 42 and channel arrangement 40 provide for smooth reinforced movement between the mounting block 30 and the door plate 28. The channel 40 is parallel with the slots 36 to enable the fore and aft movement of the door plate 28 with respect to the mounting block 30. The door receiving portion 34 includes a bearing 44 that receives a door shaft to enable the door to be positioned on the upper hinge 24.

The mounting block 30 is positioned in a channel 46 on the frame 14. The channel 46 is sized to enable the mounting block 30 to move along the axis of the channel 46 to provide a second degree of movement for the upper hinge 24. Generally, this provides a side to side movement of the door 20. The panel 18 also includes slots 48 above the channel 46 to enable the fasteners 38 to move while secured with the door plate 28. These slots 48 are substantially perpendicular to the slots 36 of the mounting portion 32.

The lower hinge 26 includes a base 50 and a door receiving portion 52. The base 50 includes at least one, three are shown, elongated slots 54. The slots 54 enable the base 50 to be moved fore and aft on the frame 14. Thus, this enables adjustment of the door 20 with respect to the housing unit 12. The door receiving portion 52 is positioned transversely with respect to the base portion 50. The door receiving portion 52 includes a bearing 56 that receives the door shaft. The lower hinge 26 has an overall L shape with the base being a substantial planar portion. The door receiving portion 52 is likewise a planar portion being transverse or perpendicular to the base portion 50. Thus, the base portion 50 may be secured to the frame 14 while the door receiving portion projects from the housing unit 12 enabling the door 20 to be received within the bearing.

During assembling, the hinge system 20 is positioned onto the frame 14. The fasteners in the slots of the hinge 24, 26 are tightened into the frame 14 and mounting block 30, respectively. They are not fully fastened and enable the door 20 to move with respect to the housing unit 12. The door 20 is positioned onto the housing unit 12 and is manipulated to eliminate any gaps and to provide a desired fit which, in turn, provide a desired finish. Once the door has been manipulated into place, the fasteners are tightened to secure the hinges 24, 26 in position with respect to the housing unit 12. During adjustment, the top or upper hinge 24 may be moved side to side by the mounting block 30 moving in the frame channel 46 as well as the door plate 28 being moved fore and aft to accommodate for the fit of the door with respect to the housing unit 12. The lower hinge 26 enables fore and aft movement due to the slots 54 positioned on the base 56. Thus, the first hinge is positioned with respect to the second hinge so that the elongated slots are positioned with respect to one another to enable a first and second adjustment direction, fore and aft, of the door.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hinge assembly for a door for a household appliance comprising:
a first hinge and a second hinge;
the first hinge including a base portion and a door receiving portion, the base portion including at least one elongated slot for receiving a fastener, the at least one elongated slot enabling positioning of the door receiving portion;
the second hinge including a mounting block and a door plate, the door plate has a door receiving portion including at least one elongated slot for enabling positioning of the door receiving portion, the door plate is secured via at least one fastener to the mounting block and the mounting block is movable in a direction substantially perpendicular to the door plate for positioning the door.

2. The hinge assembly according to claim 1, wherein the first hinge is positioned with respect to the second hinge so that the elongated slots are positioned with respect to one another to enable a first and second adjustment direction of the door.

3. The hinge assembly according to claim 2, wherein the first and second directions are fore and aft.

4. The hinge assembly according to claim 2, wherein the mounting block enables movement in a direction substantially transverse to the first and second movement directions.

5. The hinge assembly according to claim 4, wherein the transverse movement enables side to side adjustment of a door.

6. The hinge assembly according to claim 1, wherein the door receiving portion includes a bearing to receive a door shaft.

7. The hinge assembly according to claim 1, wherein the door plate includes a channel running parallel with the at least one slot.

8. The hinge assembly according to claim 7, wherein the mounting block includes a tongue engaging the channel for enabling movement of the door plate with respect to the mounting block.

9. An appliance device such as washer/dryer/refrigerator or the like comprising:
a frame, panels secured to the frame defining a housing unit;
a treatment device inside the housing unit, the housing unit including an opening for receiving a door and a door hinge system secured with the frame, the door hinge system comprising:
a first hinge and a second hinge;
the first hinge including a base portion and a door receiving portion, the base portion including at least one elongated slot for receiving a fastener, the at least one elongated slot enabling positioning of the door receiving portion;
the second hinge including a mounting block and a door plate, the door plate has a door receiving portion including at least one elongated slot for enabling positioning of the door receiving portion, the door plate is secured via at least one fastener to the mounting block and the mounting block is movable in a direction substantially perpendicular to the door plate for positioning the door.

10. The appliance device according to claim 9, wherein the first hinge is positioned with respect to the second hinge so that the elongated slots are positioned with respect to one another to enable a first and second adjustment direction of the door.

11. The appliance device according to claim 10, wherein the first and second directions are fore and aft.

12. The appliance device according to claim 10, wherein the mounting block enables movement in a direction substantially transverse to the first and second movement directions.

13. The appliance device according to claim 12, wherein the transverse movement enables side to side adjustment of the door.

14. The appliance device according to claim 9, wherein the door receiving portion includes a bearing to receive a door shaft.

15. The appliance device according to claim 9, wherein the door plate includes a channel running parallel with at least one slot.

16. The appliance device according to claim 15, wherein the mounting block includes a tongue engaging the channel for enabling movement of the door plate with respect to the mounting block.

17. The appliance device according to claim 9, wherein the frame includes a channel for receiving the mounting block, the channel is sized to enable movement of the mounting block along the frame channel.
